(19) United States
(12) Patent Application Publication
(10) Pub. No.: US 2001/0027471 A1
(43) Pub. Date: Oct. 4, 2001

(54) Order aggregation system for international shipments

(76) Inventors: Amy Paulose, Federal Way, WA (US); George Paulose, Federal Way, WA (US)

Correspondence Address: PERKINS COIE LLP, PATENT-SEA, P.O. BOX 1247, SEATTLE, WA, 98111-1247, US

(21) Appl. No.: 09/765,769

(22) Filed: Jan. 18, 2001

Related U.S. Application Data
(60) Provisional application No. 60/176,655, filed on Jan. 18, 2000.

(51) Int. Cl. G06F 17/60; G06F 7/00; G06F 17/00; G06F 15/16

(52) U.S. Cl. 709/203; 705/1; 707/104.1

(57) ABSTRACT

An aggregation system for aggregating multiple orders from different customers into a single shipment. The aggregation system is an Internet based system that allows products to be purchased and shipped internationally. The aggregation system allows a customer in one country to interact with a web server to order an item to be shipped from another country. When the aggregation system receives an order for product, it forwards the order to a supplier who can supply the product with instructions on a shipping location to which the product should be delivered.

### CROSS-REFERENCE TO RELATED APPLICATION

This application claims priority from U.S. Provisional Application No. 60/176,655, entitled “ORDER AGGREGATION SYSTEM FOR INTERNATIONAL SHIPMENTS,” filed Jan. 18, 2000 (Attorney Docket No. 31135-8001US), which is incorporated herein by reference.

### TECHNICAL FIELD

The described technology relates to an aggregation system for aggregating multiple orders from different customers into a single shipment.

### BACKGROUND

Because it facilitates electronic communications between vendors and purchasers, the Internet is increasingly being used to conduct “electronic commerce.” The Internet comprises a vast number of computers and computer networks that are interconnected through communication channels. Electronic commerce refers generally to commercial transactions that are at least partially conducted using the computer systems of the parties to the transactions. For example, a purchaser can use a personal computer to connect via the Internet to a vendor's computer. The purchaser can then interact with the vendor's computer to conduct the transaction. Although many of the commercial transactions that are performed today could be performed via electronic commerce, the acceptance and wide-spread use of electronic commerce depends, in large part, upon the ease-of-use of conducting such electronic commerce. If electronic commerce can be easily conducted, then even the novice computer user will choose to engage in electronic commerce. Therefore, it is important that techniques be developed to facilitate conducting electronic commerce.

The World Wide Web portion of the Internet is especially conducive to conducting electronic commerce. Many web servers have been developed through which vendors can advertise and sell product. The products can include items (e.g., music) that are delivered electronically to the purchaser over the Internet and items (e.g., books) that are delivered through conventional distribution channels (e.g., a common carrier). More generally, an item is any product, server, or exchangeable entity of any type. A server computer system may provide an electronic version of a catalog that lists the items that are available. A user, who is a potential purchaser, may browse through the catalog using a browser and select various items that are to be purchased. When the user has completed selecting the items to be purchased, the server computer system then prompts the user for information to complete the ordering of the items. This purchaser-specific order information may include the purchaser's name, the purchaser's credit card number, and a shipping address for the order. The server computer system then typically confirms the order by sending a confirming web page to the client computer system and schedules shipment of the items.

### BRIEF DESCRIPTION OF THE DRAWINGS

FIG. 1 is a block diagram illustrating the components really to the aggregation system.

FIG. 2 is a flow diagram illustrating sample processing of a consolidating component in one embodiment.

FIG. 3 is a flow diagram illustrating processing of a shipping component.

The shipping component coordinates the shipping process for the shipment.

### DETAILED DESCRIPTION

An aggregation system for aggregating multiple orders from different customers into a single shipment is provided. In one embodiment, the aggregation system is an Internet based system that allows products to be purchased and shipped internationally. The aggregation system allows a customer in one country to interact with a web server to order an item to be shipped from another country. When the aggregation system receives an order for product, it forwards the order to a supplier who can supply the product with instructions on a shipping location to which the product should be delivered. The aggregation system also informs the customer of an anticipated customer delivery date based on a projection of when the order will be shipped from the sending country. The aggregation system may estimate a customer delivery date based upon available space on shipments scheduled to ship after the product is anticipated to be delivered to the shipping location. When the product is delivered to the shipping location, the aggregation system coordinates the combining of the product with other product to be shipped in the same shipment. For example, the products from various orders may be combined into a single shipping container. The aggregation system may schedule shipments on regular intervals and may also schedule shipments based on how full the shipment is. When the time for shipment arrives, the aggregation system may generate all the appropriate paperwork (e.g., bill of lading) for the international shipment. The aggregation system may also electronically notify the customs authority of the destination country to facilitate clearance and may notify via electronic mail the customer that the product has been shipped.

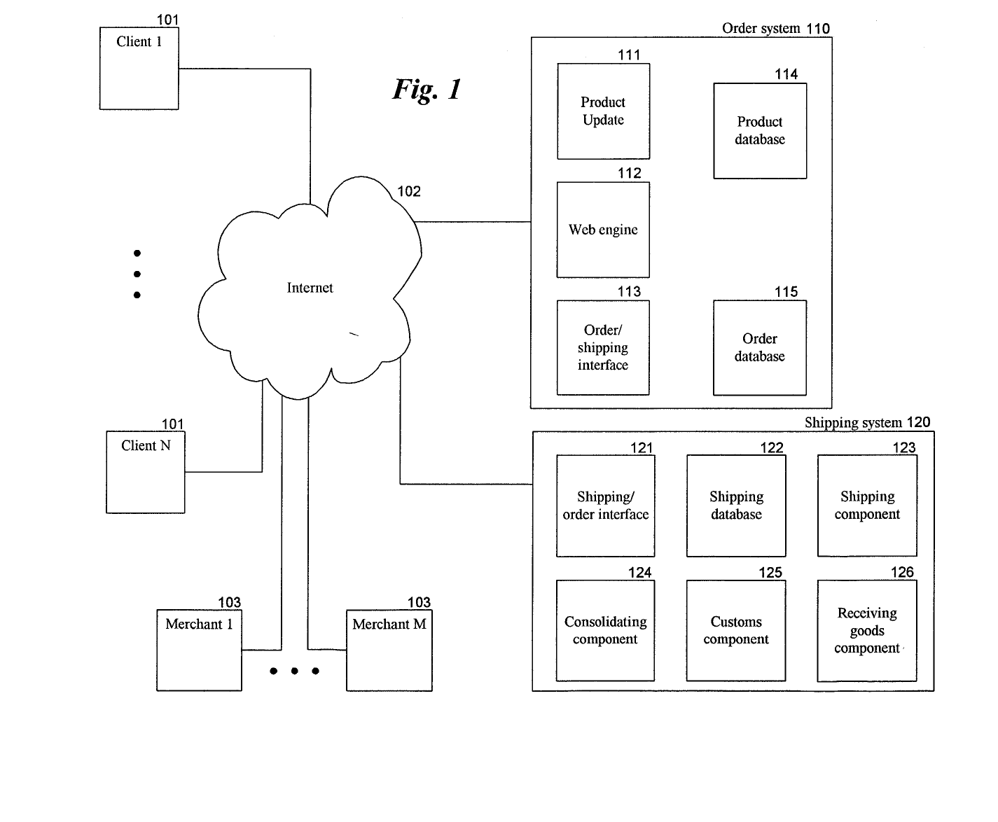

FIG. 1 is a block diagram illustrating the components really to the aggregation system. The various customer computers 101 may be connected to the aggregation system via the Internet 102. The aggregation system includes an order system 110 and a shipping system 120. The computer systems for the various merchants 103 who supply the product may also be connected to the Internet. The order system includes a product update component 111, a web engine 112, an order/shipping interface 113, a product database 114, and an order database 115. The web engine receives request for web pages from customers and coordinates the supplying of the web pages to the customers. These web pages provide the functionality for a customer to review the available products that are identified in the product database and to place orders that are then stored in the order database. The product update component interacts with the various merchants systems to identify which products are available from which merchants. The product update component may be automated in the sense that the product information is automatically retrieved from a merchant computer or may provide a manual entry for this information. The product update component stores the product information in the product database. The order/shipping interface notifies a merchant when and order has been placed and notifies the shipping system. The notification to the merchant also includes an indication of the shipping location to which the product should be delivered. The order/shipping interface retrieves the order information from the order database. The notifications to the merchants and the shipping system may be sent periodically (e.g, on a daily basis). The shipping system includes a shipping/order interface 121, a shipping database 122, a shipping component 123, a consolidating component 124, a customs component 125, and a receiving goods component 126. The shipping/order interface receives information describing the various orders and stores the information in the shipping database. The consolidating component is responsible for identifying the shipment into which each order should be consolidated. The shipping database contains information describing the scheduled shipments and the orders that have been scheduled for that shipment. The shipping component coordinates the generation of various documents that are needed to accompany a shipment. The customs component interacts electronically with the custom authorities of the destination country to facilitate clearance. The receiving goods component is used attracted the receipt of products delivered to the shipping location and coordinates to be adding of the product to the appropriate shipment. One skill in the art would appreciate that the order system and the shipping system may be implemented on a single computer system, may be implemented on multiple computer systems, may be implemented via different web sites, and so on. In general, many different overall architectures may be used to support the aggregation system. The aggregation system also provides various interfaces for allowing customers to track the shipment of their orders. This order status component may interact with both be order system and the shipping systems to identify order status.

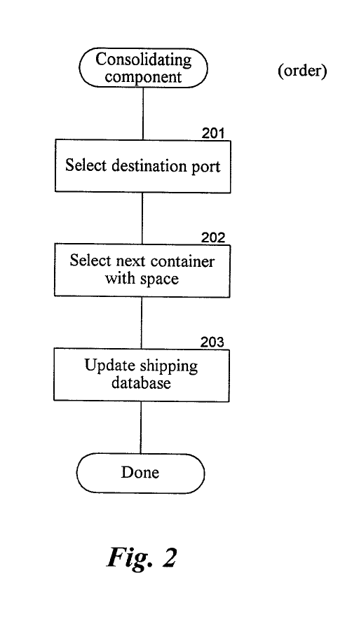

FIG. 2 is a flow diagram illustrating sample processing of a consolidating component in one embodiment. The consolidating component may be invoked whenever and order is received. Alternatively, the consolidating component may be invoked periodically to process various orders that have been received over that period. In block 201, the component selects a destination port for the order. The component may select the destination port based on the destination city and country. Each city may be assigned a particular destination port based upon its proximity to that destination port. In block 202, the component selects the next available shipment that is destined to that port which has space for that order. In block 203, the component updates the shipping database to reflect that the order has been assigned to that shipment. The component then completes.

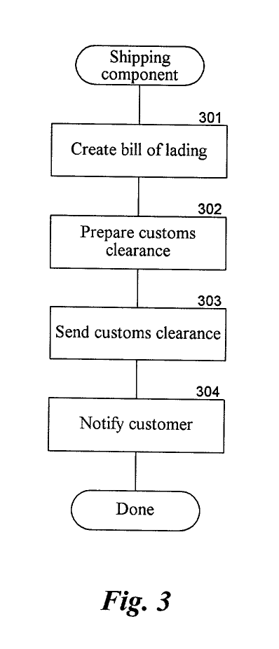

FIG. 3 is a flow diagram illustrating processing of a shipping component. The shipping component coordinates the shipping process for the shipment. In block 301, the shipping component creates a bill of lading for the shipment. The component may print out or electronically send the bill of lading, as appropriate. In block 302, the component prepares the necessary information for customs clearance. The component may invoke routines of the customs component. In block 303, the component sends the customs clearance information to the customs office of the destination country. In one embodiment, the customs clearance information is sent electronically to the customs offices. In block 304, the component may send an electronic mail to the customer indicating that the product is being shipped and indicating the anticipated delivery date to the customers location. The component then completes.

The Appendix describes additional aspects of this technology.

1. A method in a computer system of aggregating orders for multiple customers into a single shipment, comprising:
receiving orders for product from the customers;
forwarding each received order to a supplier who can supply the ordered product along with location for delivery of the ordered product;
identifying containers in which the products for the orders are to be shipped;
notifying the customer of a ship date for the container that will contain the ordered product; and
directing the loading of ordered products into the identified containers.
